(19) United States
(12) Patent Application Publication
(10) Pub. No.: US 2013/0001916 A1
(43) Pub. Date: Jan. 3, 2013

(54) WHEELED SCOOTER

(76) Inventors: AMBER ORENSTEIN, Prior Lake, MN (US); LOUIS F. POLK, III, EXCELSIOR, MN (US); JASON NESS, VICTORIA, MN (US)

(21) Appl. No.: 13/175,609

(22) Filed: Jul. 1, 2011

(51) Int. Cl. B62M 1/00; B62D 39/00

(52) U.S. Cl. 280/200; 280/33.998

(57) ABSTRACT

A scooter includes a main body having a triangular shape including three lower pivotable wheels. Three handles are defined interior to the main body, one along each of the sides. The body includes a domed shape and a textured surface. A central opening is provided in the main body to allow for stacking of the scooters for storage. During stacking, the scooters are alternated relative to one another so that the points and the sides are offset, resulting in compact and secure storage.

### FIELD OF THE INVENTION

The present invention relates to a wheeled scooter.

### BACKGROUND

Wheeled scooters are known for sliding across surfaces such as gymnasium floors or outdoor exercise or play areas. The wheeled scooter is non-motorized and is ridden by a user for exercise, playing games or entertainment purposes. Improvements are desired.

### SUMMARY

One aspect of the invention relates to a scooter including a main body having a triangular shape including three equal sides and three equal points, and three wheels. One of the wheels is located adjacent to each point. Each of the wheels includes a swivel caster wheel. Three handles are provided, wherein each handle is defined by an opening through the main body. One of the handles is located adjacent to a center of each side.

In one embodiment, the main body has a domed shaped top surface with a highest location adjacent to a center of the main body and a plurality of lower locations adjacent each of the three points.

In another embodiment, the top surface includes a textured surface.

In a further embodiment, the openings which form the handles are located within the outer perimeter of the main body, wherein the sides define outwardly bowed shapes extending between the points.

In one embodiment, the main body includes a central opening extending vertically through the main body. The central opening preferably includes an upper main diameter portion and a lower smaller diameter portion. The central opening allows stacking wherein the lower smaller diameter portion of a first scooter of a plurality of separate scooters is sized to be received in the upper main diameter portion of a second scooter of the plurality of the separate scooters positioned below the first scooter, wherein the wheels of the first scooter positioned above the second scooter do not interfere with the scooter below. In a preferred arrangement, the scooters are alternated in the stack wherein the alternating scooters are oriented at 60 degrees offset.

Another aspect of the invention relates to a scooter body including: a main body having a triangular shape including three equal sides and three equal points; three wheels mounts, one of the wheel mounts being located adjacent to each point; three handles, each handle defined by an opening through the main body, one of the handles being located adjacent to a center of each side. The main body has a domed shaped top surface with a highest location adjacent to a center of the main body and a plurality of lower locations adjacent each of the three points. The main body defines a carrying handle adjacent to each handle, the carrying handle having a thinner vertical dimension than portions of the sides on opposite ends of the carrying handle.

A further aspect of the invention relates to stack of scooters and a related method of stacking including a plurality of separate scooters, each scooter including:

a main body having a triangular shape including three equal sides and three equal points;

three wheels, one of the wheels being located adjacent to each point, each of the wheels including a swivel caster wheel;

three handles, each handle defined by an opening through the main body, one of the handles being located adjacent to a center of each side;

the main body having a domed shaped top surface with a highest location adjacent to a center of the main body and a plurality of lower locations adjacent each of the three points;

the main body having a central opening extending vertically through the main body, wherein the central opening including a upper main diameter portion and a lower smaller diameter portion;

wherein the scooters are stacked and alternated back and forth in a repeating pattern along central vertical axis, wherein the lower smaller diameter portion of a first scooter of the plurality of the separate scooters is sized to be received in the upper main diameter portion of a second scooter of the plurality of the separate scooters positioned below the first scooter, wherein the wheels of the first scooter positioned above the second scooter do not interfere with the scooter below, wherein the alternating scooters are oriented at 60 degrees offset.

In one embodiment of the stack of scooters, the main body of each scooter includes a carrying handle adjacent to each handle, the carrying handle having a thinner vertical dimension than portions of the sides on opposite ends of the carrying handle.

### BRIEF DESCRIPTION OF THE DRAWINGS

FIG. 1 is a perspective view of a first embodiment of a scooter;

FIG. 2 is a first side view of the scooter of FIG. 1;

FIG. 3 is a second side view of the scooter of FIG. 1;

FIG. 4 is a third side view of the scooter of FIG. 1;

FIG. 5 is a fourth side view of the scooter of FIG. 1;

FIG. 6 is a top view of the scooter of FIG. 1;

FIG. 7 is a bottom view of the scooter of FIG. 1;

FIG. 8 is a cross-sectional side view of two scooters shown in a stacked arrangement;

FIG. 9 is a top view of the two scooters of FIG. 8 shown in the stacked arrangement;

FIG. 10 is a bottom perspective view of the scooter of FIG. 1.

### DETAILED DESCRIPTION OF THE PREFERRED EMBODIMENT

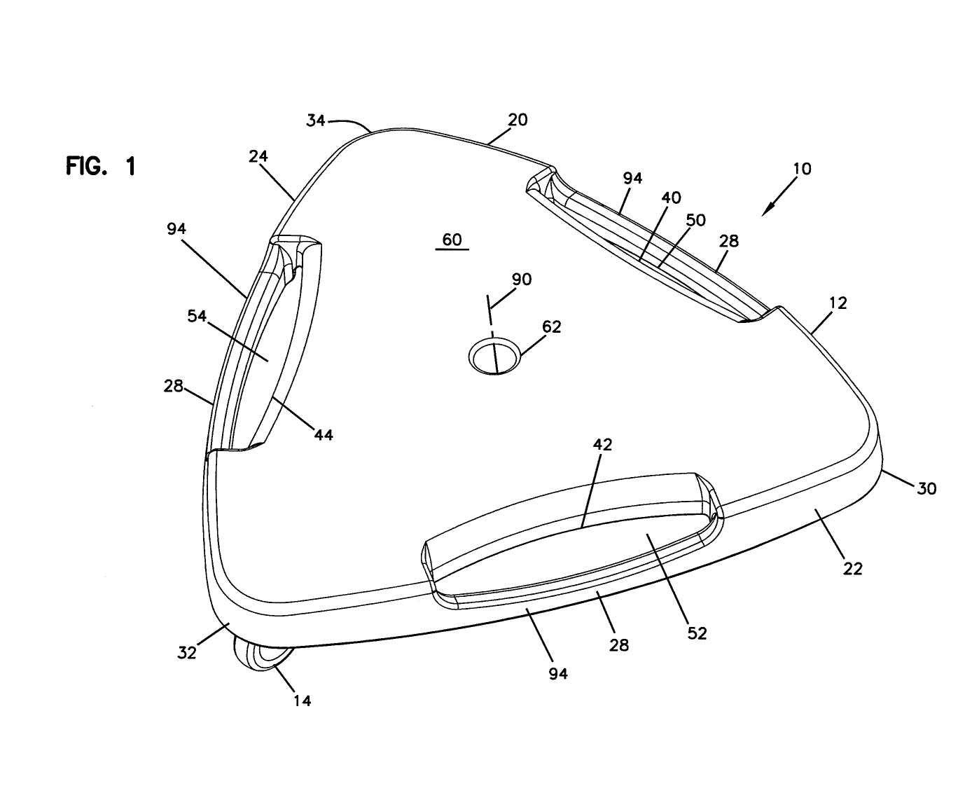

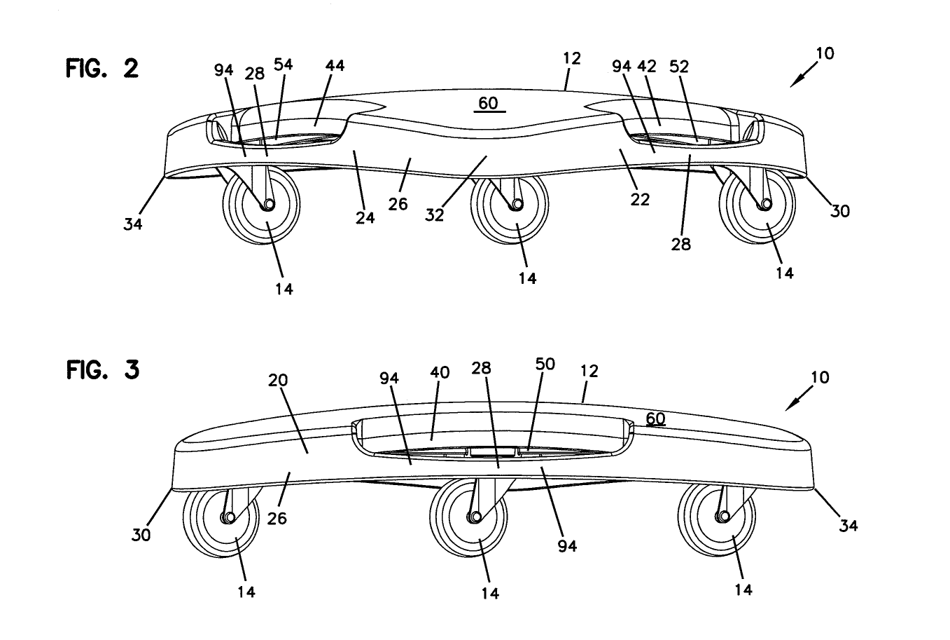

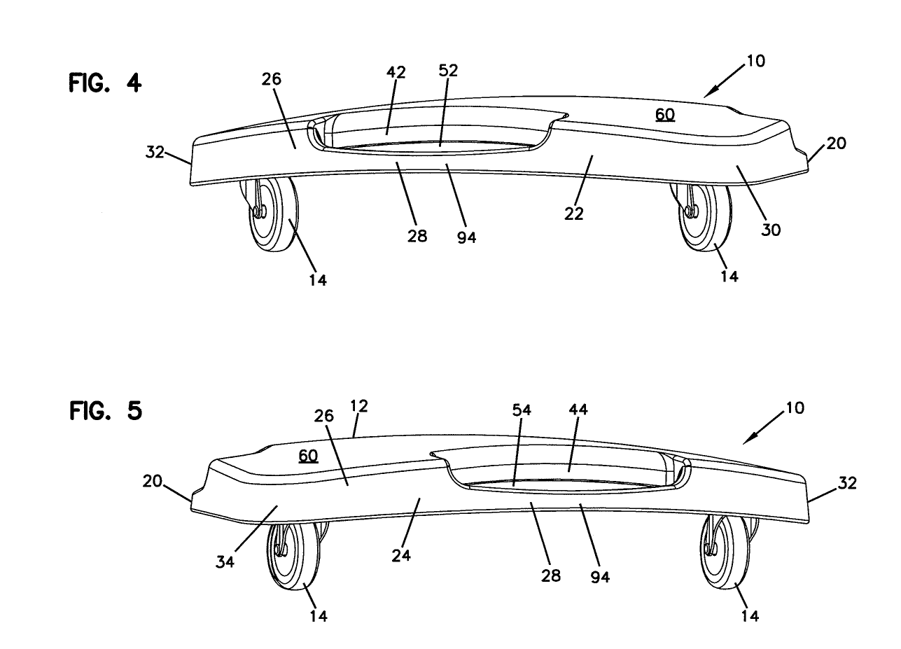

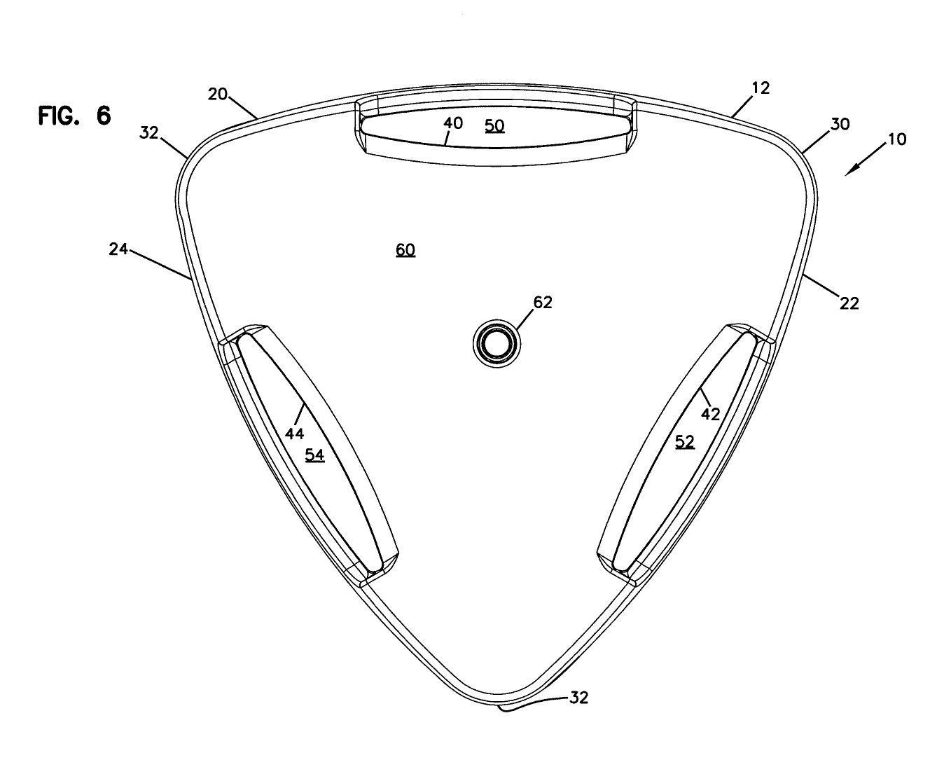

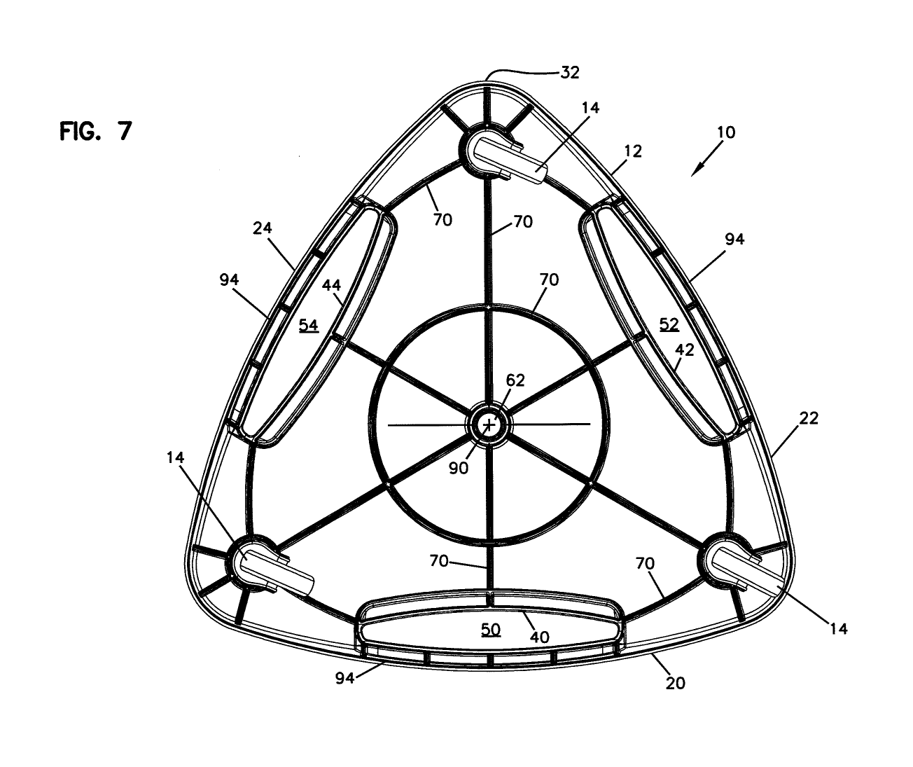

Referring now to the FIGS. 1-10, a first embodiment of a scooter 10 is shown. Scooter 10 includes a main body 12 and a plurality of wheels 14 for engagement with a surface such as a gymnasium floor or an outdoor exercise or activity area. Wheels 14 in the illustrated embodiment are swivel caster style wheels that can rotate 360 degrees about an axis perpendicular to the floor surface.

Main body 12 has a generally triangular shape including three sides 20, 22, and 24. Main body 12 includes three corners or points 30, 32, 34. Points 30, 32, 34 together with sides 20, 22, 24 define the generally triangular shape. In the illustrated embodiment, scooter 10 is symmetrically shaped through an axis extending through one side and an opposite point. In the preferred embodiment, the scooter 10 is symmetrical through any axis through any side and its opposite point. Wheels 14 are located adjacent to a respective point 30, 32, 34. Preferably, the wheels 14 are recessed slightly inwardly from the outer periphery defined by main body 12, and do not protrude beyond the outer periphery of main body 12.

In the illustrated embodiment, sides 20, 22, 24 are slightly rounded or bowed outwardly. Further, in the illustrated embodiments, points 30, 32, 34 are rounded.

The triangular shape and three wheeled arrangement provides a stable design that is less tippable compared to designs with four or more wheels.

Main body 12 includes a plurality of handles or gripping portions 40, 42, 44 for gripping by at least one user of scooter 10. Handles 40, 42, 44 are spaced inwardly from sides 20, 22, 24. An opening 50, 52, 54 is defined adjacent to each respective handle 40, 42, 44 to allow for receipt of the user's hands. The user grips the handles 40, 42, 44 by inserting the user's hands into one or more of the openings 50, 52, 54, with palms inward and griping the top, the side and/or the bottom of handle 40, 42, 44. In one embodiment, handles 40, 42, 44 can accommodate two hands.

Top surface 60 of body 12 defines a seating surface for the user. The user then grips main body 12 at one or more handles 40, 42, 44 if desired. It is to be appreciated that top surface 60 can receive a plurality of users if desired. Further, top surface 60 can receive the user or users in a variety of positions including sitting, or laying across the top, such as by laying on the user's stomach.

Top surface 60 includes a generally domed shape wherein the highest upper portion is adjacent to a center opening 62, and the lower upper areas are adjacent to points 30, 32, 34.

Top surface 60 preferably includes a textured or roughened surface construction to prevent or reduce sliding of the user relative to the top surface 60. Such texturing can be applied during manufacture, such as by molding main body 12 from plastic and providing the texturing to the top surface.

Referring now to FIGS. 7 and 10, main body 12 includes a plurality of ribbings or webbings 70 to improve strength without significantly increasing the unit's weight. As it can be appreciated, ribbings 70 can take a variety of shapes and numbers, as desired.

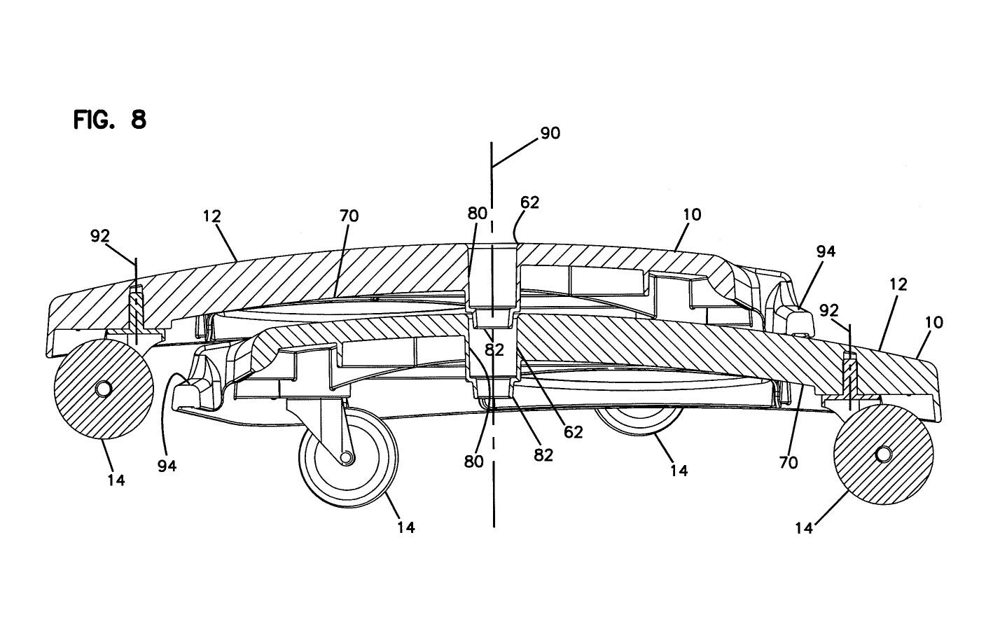

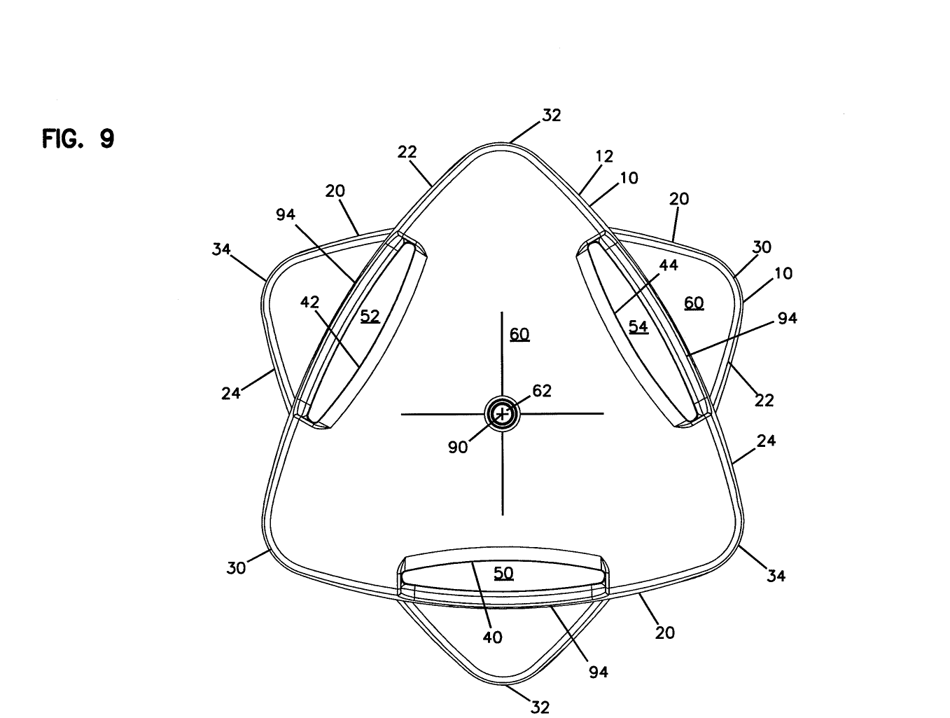

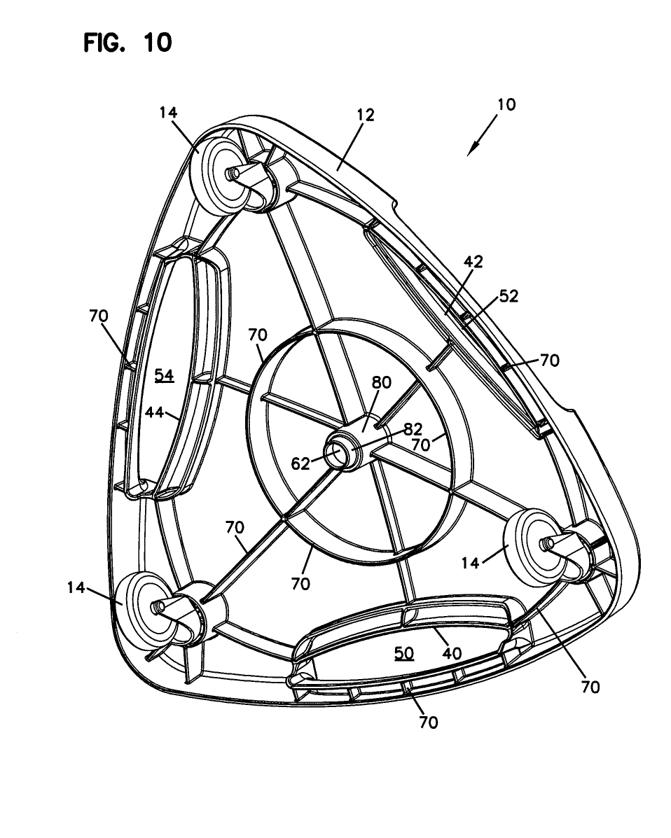

Center opening 62 is provided with an upper main diameter portion 80 and a lower portion 82 having a smaller outer diameter. Referring to FIGS. 8 and 9, lower portion 82 of a first scooter 10 is sized to be received in main diameter portion 80 of a second scooter 10 positioned below the first scooter. In this manner, the scooters can be stacked for storage.

In FIGS. 8 and 9, only two scooters 10 are shown stacked together for storage. It is to be appreciated that a plurality of additional scooters can be stacked, such as 6-12, or more. When stacking the scooters 10, they are alternated back and forth in a repeating pattern as shown in FIGS. 8 and 9 along axis 90. During stacking, the scooters are alternated so that the wheels of the scooter positioned above do not interfere with the scooter below, thereby resulting in more compact storage. The alternating is oriented at 60 degrees offset. A 180 degree offset is also possible. A nesting effect is created by the offset. In some embodiments, 24 scooters can be conveniently placed in one stack.

With the noted storage feature, the scooters 10 are self-stacking in the preferred arrangement, in that no stacking pole or other storage cart is needed. Also, the compact fit allows more scooters 10 to be stored than if they were stacked bottom to top (bottom of the wheels to top of the underneath scooter) where there was no overlap.

Sides 20, 22, 24 of main body 12 include a main thickness 26 adjacent to each point 30, 32, 34 and a portion of each side 20, 22, 24. Along a center of sides 20, 22, 24 adjacent to each handle 40, 42, 44 is a thinner portion 28. Thinner portion 28 defines a carrying handle 94. Carrying handle 94 also protects the hands of the user or users in handles 40, 42, 44 from being contacted by walls, objects or another scooter.

Carrying handles 94 do not project outwardly from sides 20, 22, 24, and instead are part of the smooth curve of the sides 20, 22, 24 connecting the points 30, 32, 34. The non-protruding wheels protect the wheels from contacting walls, objects, or another scooter.

Wheels 14 each pivot about a wheel axis 92 so that scooter 10 can be moved in any direction, such as in a straight path or a curved path as directed by the user or someone pushing the user. The user moves the scooter 10 by pushing with the user's hands and/or feet, or with a stick or other oar-like object. Also, the user can be pushed by another person pushing on the scooter or the user.

The wheels 14 can be press-fit or snap mounted to main body 12. Different wheels can be provided for scooter 10, depending on cost, desired speed, type of surface the scooter 10 will be used on, or other factors.

Scooter 10 can be used in a variety of manners for exercise or entertainment, including racing, in games with balls or objects, and in agility training or testing.

What is claimed is:

1. A scooter comprising:
a main body having a triangular shape including three equal sides and three equal points;
three wheels, one of the wheels being located adjacent to each point, each of the wheels including a swivel caster wheel;
three handles, each handle defined by an opening through the main body, one of the handles being located adjacent to a center of each side;
the main body having a domed shaped top surface with a highest location adjacent to a center of the main body and a plurality of lower locations adjacent each of the three points.

2. The scooter of claim 1, wherein the top surface includes a textured surface.

3. The scooter of claim 1, wherein the openings which form the handles are located within the outer perimeter of the main body, wherein the sides define outwardly bowed shapes extending between the points.

4. The scooter of claim 1, wherein the main body includes a central opening extending vertically through the main body.

5. The scooter of claim 4, wherein the central opening includes an upper main diameter portion and a lower smaller diameter portion.

6. A scooter body comprising:
a main body having a triangular shape including three equal sides and three equal points;
three wheels mounts, one of the wheel mounts being located adjacent to each point;
three handles, each handle defined by an opening through the main body, one of the handles being located adjacent to a center of each side;
the main body having a domed shaped top surface with a highest location adjacent to a center of the main body and a plurality of lower locations adjacent each of the three points,
the main body defining a carrying handle adjacent to each handle, the carrying handle having a thinner vertical dimension than portions of the sides on opposite ends of the carrying handle.

7. The scooter of claim 6, wherein the top surface includes a textured surface.

8. The scooter of claim 6, wherein the openings which form the handles are located within the outer perimeter of the main body, wherein the sides define outwardly bowed shapes extending between the points.

9. The scooter of claim 6, wherein the main body includes a central opening extending vertically through the main body.

10. The scooter of claim 9, wherein the central opening includes a upper main diameter portion and a lower smaller diameter portion.

11. A stack of scooters comprising:
a plurality of separate scooters, each scooter including:
a main body having a triangular shape including three equal sides and three equal points;
three wheels, one of the wheels being located adjacent to each point, each of the wheels including a swivel caster wheel;
three handles, each handle defined by an opening through the main body, one of the handles being located adjacent to a center of each side;
the main body having a domed shaped top surface with a highest location adjacent to a center of the main body and a plurality of lower locations adjacent each of the three points;
the main body having a central opening extending vertically through the main body, wherein the central opening including a upper main diameter portion and a lower smaller diameter portion;
wherein the scooters are stacked and alternated back and forth in a repeating pattern along central vertical axis, wherein the lower smaller diameter portion of a first scooter of the plurality of the separate scooters is sized to be received in the upper main diameter portion of a second scooter of the plurality of the separate scooters positioned below the first scooter, wherein the wheels of the first scooter positioned above the second scooter do not interfere with the scooter below, wherein the alternating scooters are oriented at an offset.

12. The stack of scooters of claim 11, wherein the top surface of each scooter includes a textured surface.

13. The stack of scooters of claim 11, wherein the openings which form the handles are located within the outer perimeter of the main body, wherein the sides define outwardly bowed shapes extending between the points.

14. The stack of scooters of claim 11, wherein the main body of each scooter includes a carrying handle adjacent to each handle, the carrying handle having a thinner vertical dimension than portions of the sides on opposite ends of the carrying handle.

15. A method of stack including of scooters comprising:
providing a plurality of separate scooters, each scooter including:
a main body having a triangular shape including three equal sides and three equal points;
three wheels, one of the wheels being located adjacent to each point, each of the wheels including a swivel caster wheel;
three handles, each handle defined by an opening through the main body, one of the handles being located adjacent to a center of each side;
the main body having a central opening extending vertically through the main body, wherein the central opening including a upper main diameter portion and a lower smaller diameter portion;
stacking the scooters in a vertical stack, wherein the scooters are alternated back and forth in a repeating pattern along central vertical axis, wherein the lower smaller diameter portion of a first scooter of the plurality of the separate scooters is sized to be received in the upper main diameter portion of a second scooter of the plurality of the separate scooters positioned below the first scooter, wherein the wheels of the first scooter positioned above the second scooter do not interfere with the scooter below, wherein the alternating scooters are oriented at an offset, wherein the scooters overlap and are nested within one another.

16. The method of claim 15, wherein at least 3 scooters are provided.

17. The method of claim 16, wherein at least 6 scooters are provided.

18. The method of claim 17, wherein at least 12 scooters are provided.

19. The method of claim 18, wherein at least 24 scooters are provided.

20. The method of claim 15, wherein no pole or other external holder is used to maintain the stack in vertical alignment.
